(19) United States
(12) Patent Application Publication
(10) Pub. No.: US 2007/0278995 A1
(43) Pub. Date: Dec. 6, 2007

(54) Recharging power source with lighting accessory

(76) Inventors: Steven Lynn Batdorff, Sterling, VA (US); Ricky Eugene Hull, Tiffin, OH (US)

Correspondence Address: BACON & THOMAS, PLLC, 625 SLATERS LANE, FOURTH FLOOR, ALEXANDRIA, VA, 22314, US

(21) Appl. No.: 11/806,106

(22) Filed: May 30, 2007

Related U.S. Application Data
(60) Provisional application No. 60/809,408, filed on May 31, 2006.

(51) Int. Cl. H02J 7/00

(52) U.S. Cl. 320/107

(57) ABSTRACT

A mobile recharging power source with a lighting accessory includes a battery pack, the battery pack having a plurality of battery cells contained within a housing and electrically connected to a receiving connector disposed on the housing. A lamp may be provided on the housing, along with a switch to turn the lamp on and off. A lighting accessory is provided for connection to the receiving connector of the battery pack. The lighting accessory includes at least one light source, such as an incandescent or LED lamp, and the light source is connected to a mating connector which is adapted for connection to the receiving connector of the battery pack. Additionally, a charging accessory is provided having a mating connector for connection to the receiving connector, and a device specific connector adapted for connection to a recharging port of a portable electronic device.

This application claims the benefit of U.S. Provisional Application No. 60/809,408 filed May 31, 2006.

### FIELD OF THE INVENTION

The present invention relates to a mobile power source for charging a portable electronic device, and more particularly to a recharging power source with lighting accessory including a device for charging a portable electronic device, such as a cellular telephone or the like, and lighting accessory such as a flashlight.

### BACKGROUND

Portable electronic devices that are powered by a rechargeable power source are currently in widespread use. Cellular telephones, pagers, personal digital assistants (PDAs), digital cameras, portable music devices, and other types of portable electronic devices typically rely on rechargeable batteries, and these devices have gained wide acceptance both as a convenience, and for some people, as a necessity.

Cellular telephones, for example, have been adopted by some users as a sole means of telephonic communication. Also, cellular telephones are frequently maintained for emergency use, such as in the event of automobile difficulties that may occur remotely from service or repair facilities. Moreover, during the course of severe weather or a natural disaster or other event that may disrupt conventional landline telephone services, many cellular telephone users are able to communicate for emergency assistance even though landline communication services may be unavailable.

Unfortunately, usefulness of these portable electronic devices is limited by the capacity of their rechargeable batteries, and by the ability of the user to recharge them. While improvements in the charge capacity of rechargeable batteries occur steadily, rechargeable batteries of even the best technology, if not timely recharged, eventually become discharged and the devices they power become useless until recharging may be performed.

The ability to charge rechargeable batteries is dependant upon the availability of another power source. Typically, a battery charger is an electrical device that is powered by a conventional 110V-120V alternating current (AC) power source. Alternatively, some devices are adapted to use the 12V direct current (DC) power available from a vehicle, often through a “cigarette lighter” adapter or the like.

Unfortunately, access to conventional power sources is not always available when a portable electronic device's batteries go dead. And, during the course of an emergency situation, unavailability of a conventional power source to recharge batteries for a portable electronic device may be widespread and prolonged.

Various devices have been developed which use one or more batteries as a recharging power source to provide a mobile power source for charging a portable electronic device.

However, given the unpredictable nature of timing of the loss of function of a portable electronic device due to the loss of charge of its batteries, it may well be the case that such a situation arises at night or in the dark. Even during daylight hours, the loss of power to a building may leave occupants of the building without sufficient light to find their way.

Thus, the utility of a mobile power source for charging a portable electronic device may be enhanced, both as a matter of convenience and as a matter of necessity during an emergency situation, by the provision of a lighting source along with the mobile power source.

### SUMMARY

The present invention relates to a recharging power source with a lighting accessory, which includes an electrical power source for charging a portable electronic device, such as a cellular telephone or the like, and a lighting accessory such as a flashlight that is powerable by the electrical power source.

The recharging power source with a lighting accessory comprises an electrical power source in the form of a battery pack that provides a suitable voltage for recharging a portable electronic device. The battery pack is provided with a single power connection through which a charging current may be supplied from the battery pack to the portable electronic device, and through which a recharging current may be received to recharge rechargeable battery cells of the battery pack itself.

With the lighting accessory in place connected to the battery pack, the single power connection provides an electrical current to the lighting accessory, so that the battery pack and the lighting accessory together function as a light source or flashlight.

When the lighting accessory is removed, the single power connection is adapted for connection to a charging port of a portable electronic device to charge the portable electronic device, and for connection to an external charging power supply to recharge batteries contained within the battery pack.

These and other features, aspects, and advantages of the present invention will become better understood with regard to the following description, appended claims, and accompanying drawings.

### BRIEF DESCRIPTION OF THE DRAWINGS

FIG. 1 is an exploded perspective view of a recharging power source and lighting accessory according to one embodiment of the present invention.

FIG. 2 is a perspective view of a battery pack according to one embodiment of the present invention adapted for recharging a portable electronic device.

FIG. 3A is an exploded perspective view of one embodiment of a battery pack.

FIG. 3B is an exploded perspective view of another embodiment of a battery pack.

FIG. 3C is a front perspective view of another embodiment of a battery pack, including a slidably removable cover.

FIG. 3D is a front perspective view of the embodiment of FIG. 3C showing the cover in a partially opened position.

FIG. 3E is a rear perspective view of the embodiment of FIG. 3C.

FIG. 4 is a diagrammatic view of the recharging power source and lighting accessory of FIG. 1.

FIG. 5 is a perspective view of an embodiment of a battery pack of the present invention configured to be carried in a belt holster or clip.

FIG. 6 is a diagrammatic view of a battery pack of the present invention along with variously embodied lighting accessories, charging adapters, and charging devices.

FIG. 7 is a perspective view of a further embodiment of the present invention.

Similar reference characters denote corresponding features consistently throughout the attached drawings.

### DETAILED DESCRIPTION OF VARIOUS EMBODIMENTS

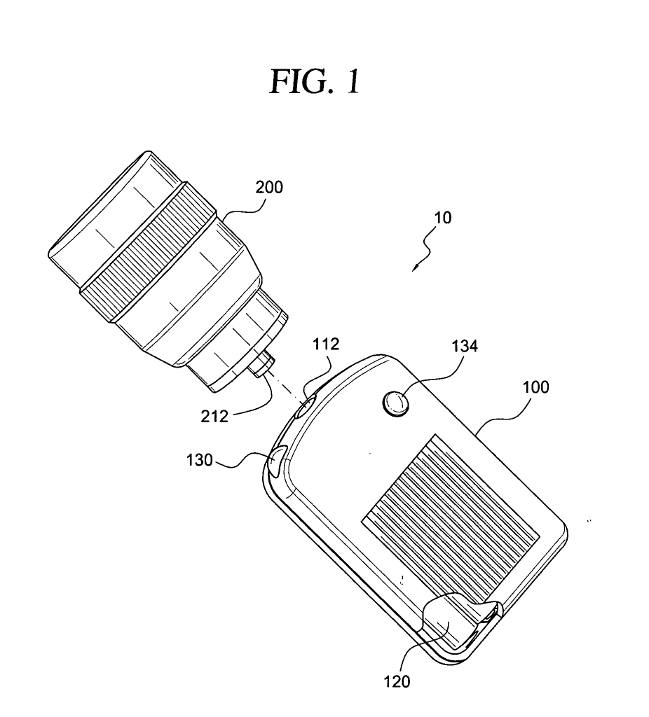

The present invention is a recharging power source with a lighting accessory. Referring to FIG. 1, an embodiment of a recharging power source with a lighting accessory 10 is shown. In the illustrated embodiment, a battery pack 100 is provided with a receiving connector 112, and a lighting accessory 200 is provided with a mating connector 212 adapted for connection with the receiving connector 112.

The lighting accessory 200 is attached to the battery pack 100 by simply connecting the mating connector 212 to the receiving connector 112.

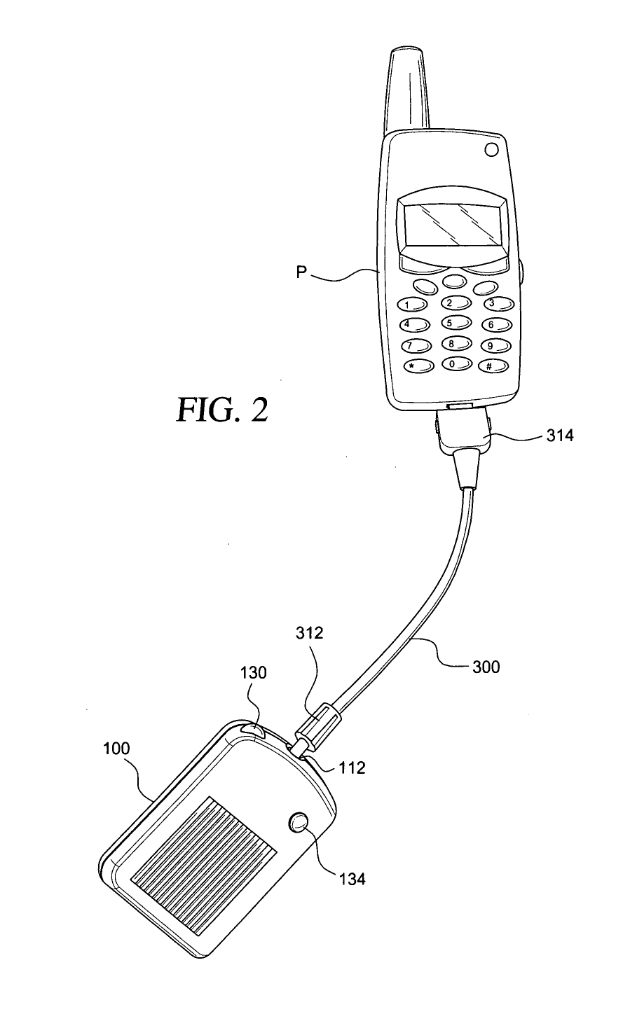

Turning to FIG. 2, the battery pack 100 is shown with a charging adapter 300 in connection with a portable electronic device P to provide a charging current to the portable electronic device P.

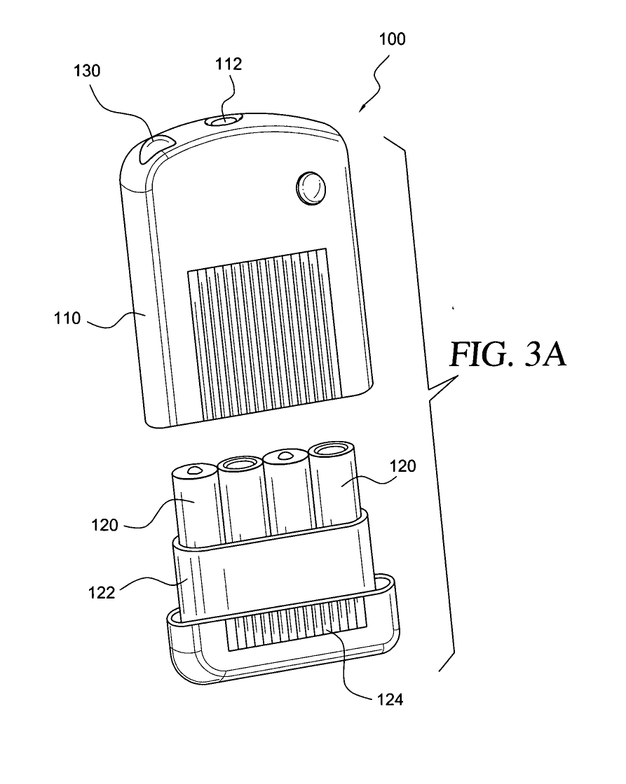

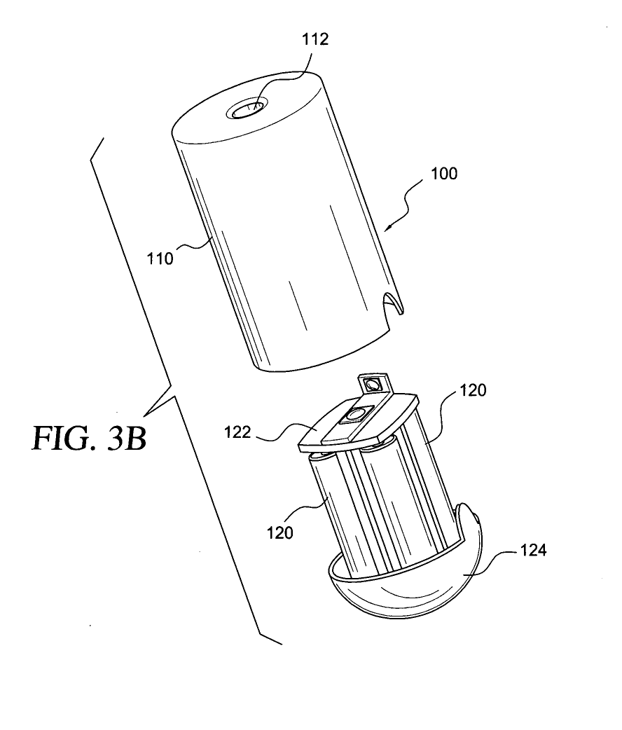

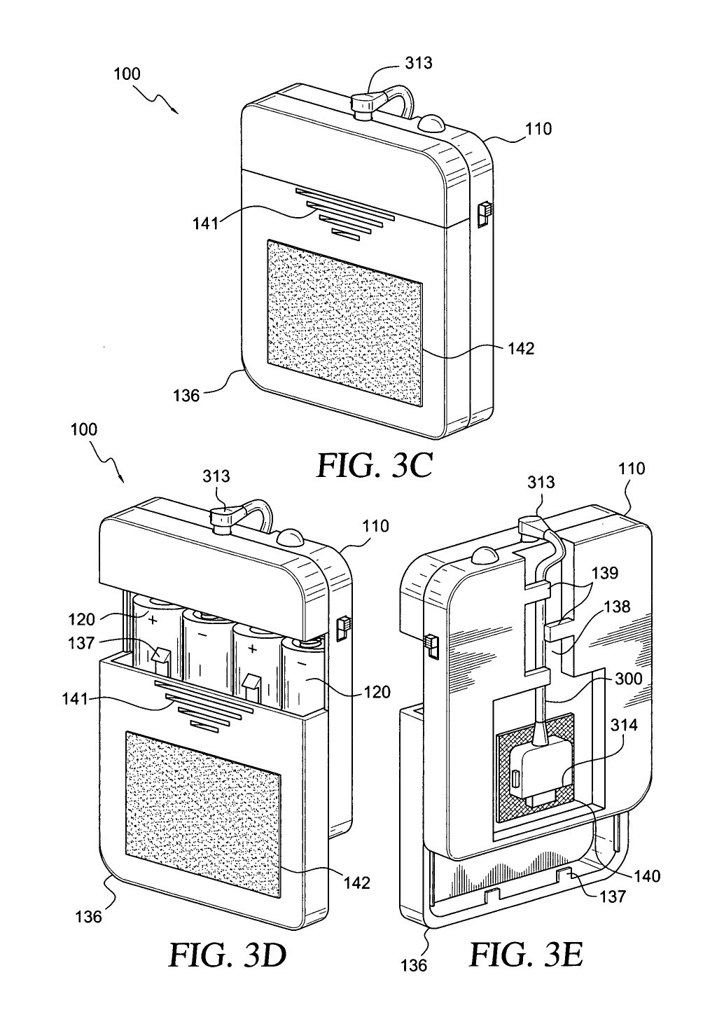

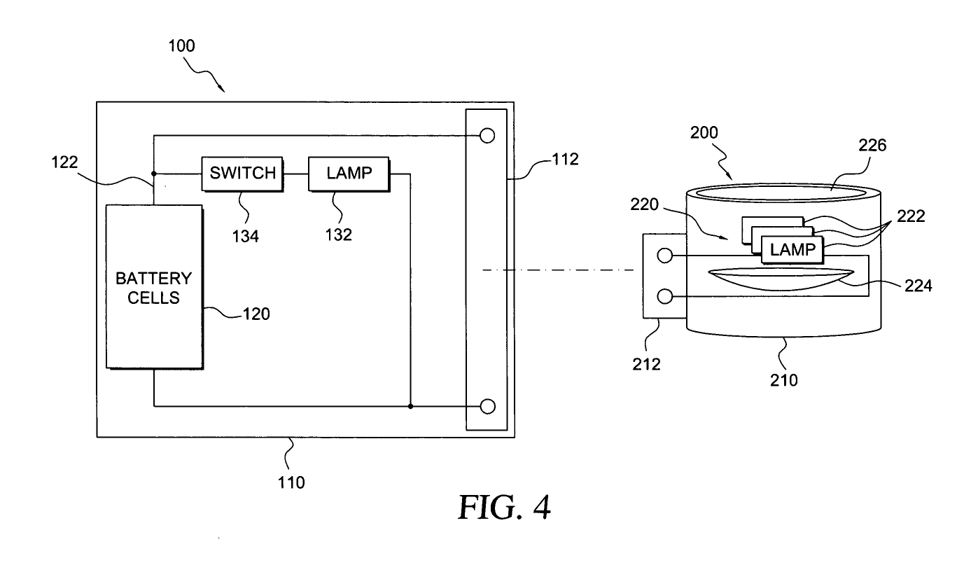

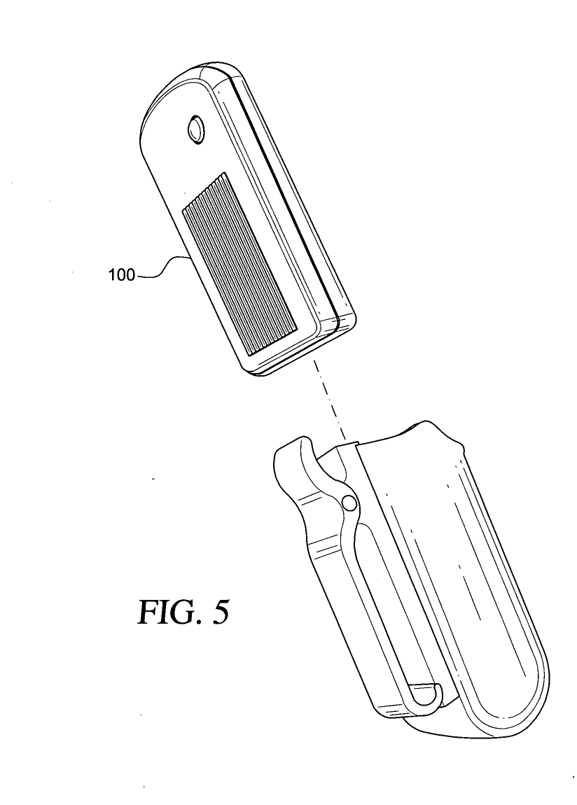

Referring to FIGS. 3A, 3B, and 4, the battery pack 100 comprises a plurality of battery cells 120 contained within a battery housing 110. The battery cells 120 are electrically connected to the receiving connector 112. In one embodiment, the receiving connector is a female USB type connector, although alternative types of connectors may be used.

The battery pack 100 may further comprise an integrated light 130 in the form of at least one lamp 132 mounted on the battery housing 110 incorporated in an electrical circuit 122 electrically connected to the battery cells 120. A switch 134 is provided in the battery circuit 122 between the lamp 132 and the battery cells 120 so that the integrated light 130 may be turned on and off.

FIGS. 3A and 3B show possible arrangements of battery cells 120. In the embodiment illustrated in FIG. 3A, four battery cells 120 are employed, and are arranged side-by-side so that the battery pack 100 may have a generally flat and rectangular shape. Such a shape is advantageous in that it may be conveniently carried in a user's pocket, or carried by a belt holster or clip as seen in FIG. 5, for ready use, although the battery cells 120 may be alternatively arranged resulting in a different shape of the battery pack 100 such as seen in FIG. 3B. In other configurations, a belt clip may be attached directly to the battery pack 100.

Additionally, because the battery pack 100 requires only a single receiving connector 112 for all of its functions, the size of the battery pack 100 may be reduced as compared to a configuration requiring multiple connectors.

It is desirable for the four battery 120 cells to provide approximately 5 volts for a charging embodiment for current cell phones. Using rechargable AA or AAA NiMH cells, which have a nominal voltage of 1.2V per cell, for the battery cells 120, a battery pack 100 comprising four battery cells 120 arranged in series will provide a voltage of 4.8V.

This arrangement provides a good charging source, and maintains a relatively level voltage until the battery cells 120 are totally discharged. With this arrangement, it is anticipated that most current cell phones will be charged to 75-80%, and many to 100%, of full capacity by the battery pack 100, even while the cell phone is in use.

Using rechargeable battery cells 120, the battery housing 110 may be sealed and made water-tight. Also, a sealed battery housing 110 prevents a user from replacing the battery cells 120 with an incorrect or inappropriate type that may cause damage to the portable electronic device.

Using conventional AA or AAA alkaline cells, which have a nominal voltage of 1.5V per cell, for the battery cells 120, a battery pack 100 comprising four series battery cells 120 will provide a voltage of 6.0V. While such a voltage may be too high for some portable electronic devices, leading to overheating during charging or use, such an arrangement does allow a user to purchase or obtain replacement batteries instead of recharging. Thus, in a situation where there is no conventional power source available to recharge the battery pack 100, such as during a local power outage, a battery pack 100 wherein the battery cells 120 are conventional and replaceable alkaline cells remains usable despite the inability for recharging by simply replacing spent battery cells 120.

In the embodiments shown in FIGS. 3A and 3B, the battery pack 100 is shown comprising a battery housing 110 having a removable battery carrier 122 which holds the battery cells 120. In these embodiments, the battery carrier 122 includes an integral housing cover 124 to close the battery housing 110.

Referring to FIGS. 3C-3E, in other embodiments a housing cover 124 may be provided separately from the battery carrier 122, such as a slidably removable cover 136. The cover 136 may include latching tabs 137 at one or both ends to latch the cover 136 in a closed position. The cover 136 may also be provided with gripping elements 141, such one or more raised or depressed bars or the like, to provide an improved gripping surface for opening or closing the cover.

The housing 110 may also include an optional channel 138 for stowing an accessory power or interconnecting cord such as a charging adapter 300. In an illustrated embodiment, the channel 138 is defined in a back side of the housing 110, although other arrangements are possible. One or more tabs 139 may be disposed along the channel 138 to removably retain the cord within the channel 138.

To facilitate stowing the cord within the channel 138 while the cord is engaged with the receiving connector 112, an L shaped connector 313 may be provided at one end of the cord. Also, a hook-and-loop or other fastening element 140 may be provided to secure an accessory connector 314 of the cord within the channel 138. In order that the battery pack 100 may be held more securely together with a portable electronic device, for example while charging the portable electronic device, a frictional pad 142 may be provided on a surface of the housing 110 or cover 136.

Referring to FIGS. 1, 4, and 6, an embodiment of a lighting accessory 200 in the form of a flashlight attachment comprises a lamp housing 210 having a light source 220 at one end, and a mating connector 212 at the other end, the mating connector 212 being adapted for connection with the receiving connector 112 of the battery pack 100. The light source 220 is electrically connected to the mating connector 212 so that an electrical current applied to the mating connector 212 illuminates the light source 220.

The light source 220 comprises at least one lamp 222 which may be an incandescent, LED, or another type or lamp. The at least one lamp 222 may be disposed on, or in front of, a reflector 224 and the light source 220 may be protected within the lamp housing 210 by a clear lens 226.

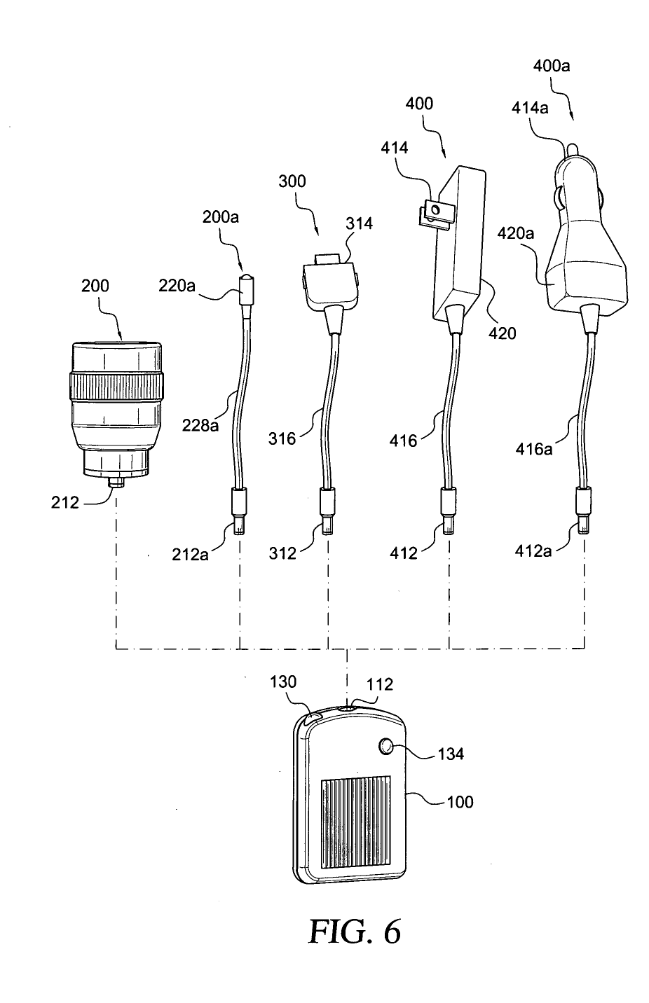

An alternate embodiment of a lighting accessory 200a is shown in FIG. 6, comprising a light source 220a in the form of a single high intensity lamp disposed at one end of a flexible extension member 228a, with the mating connector 212a disposed at the other end of the flexible extension member 228a. Numerous other arrangements may be employed for a lighting accessory 200.

A charging adapter 300 shown in FIG. 6 is used to couple the battery pack 100 to a portable electronic device P to charge the portable electronic device P. A charging adapter 300 comprises a mating connector 312 that is adapted for connection to the receiving connector 112 of the battery pack 100, and a device specific accessory connector 314 that is adapted for connection to a recharging port or connector of the portable electronic device P.

In the illustrated embodiment, the charging adapter 300 comprises a short, flexible cable 316 between the mating connector 312 and the accessory connector 314. Alternatively, the mating connector 312 and the accessory connector 314 may be directly connected to one another and retained in a single rigid body or housing, or may be of various other forms.

A charging device 400 illustrated in FIG. 6 is provided for recharging battery cells 120 of the battery pack 100. The charging device 400 has a mating connector 412 adapted for connection with the receiving connector 112 of the battery pack 100, so that a charging current supplied by the charging device 400 is provided to the battery cells 120 of the battery pack 100.

The mating connector 412 is electrically connected to a battery charger 420 which supplies the charging current. The charging device 400 may include an electrical connector such as electrical connector 414 adapted to connect the battery charger 420 to a conventional 110V-120V alternating current (AC) power source, an electrical connector 414a adapted to connect the battery charger 420a to a 12V direct current (DC) vehicle power source, or any other type of electrical connector adapted for connection to another type of power source. Alternatively, the battery charger 420 may include a self-contained power source or supply.

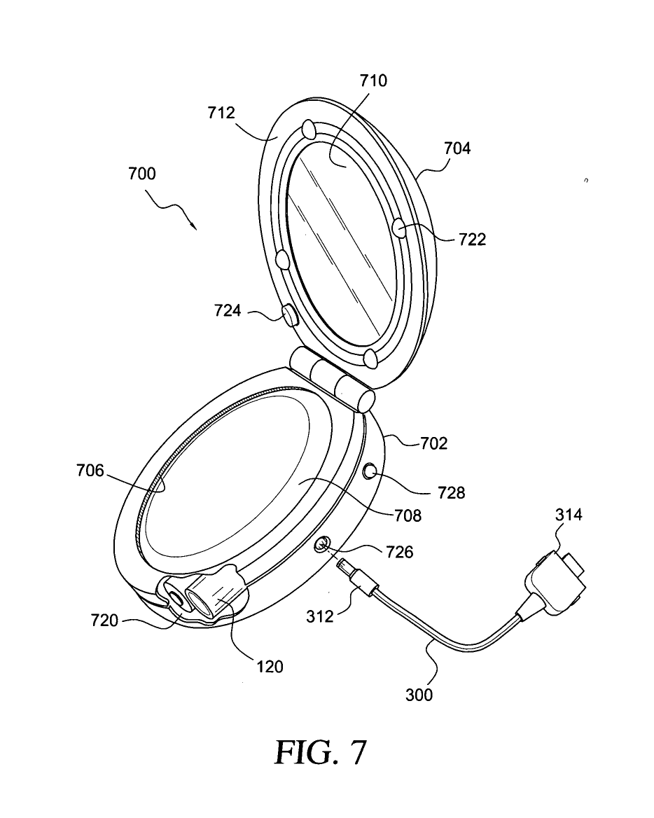

A recharging power source with a lighting accessory is not confined to the above embodiments, and may take the form of various articles incorporating the features described herein. For example, in an embodiment shown in FIG. 7, a recharging power source with a lighting accessory is provided in the form of a cosmetic compact 700.

The cosmetic compact 700 is of a generally conventional arrangement having a container portion 702 and a cover 704 hinged to the container portion 702. The container portion 702 includes at least one cosmetic receptacle 706 in which a cosmetic substance 708 may be provided. A mirror 710 is disposed on an inside face 712 of the cover 704.

According to the illustrated embodiment, a plurality of battery cells 120 are contained in a battery housing 720 provided in the container portion 702, forming a battery pack. Alternatively, the battery cells 120 may be provided elsewhere, such as in the cover 704.

A lighting accessory is provided in the form of at least one light source 722 disposed on or within the cover 704 of the cosmetic compact 700. For example, a plurality of lamps, light emitting diodes (LEDs), fiber optic or other light guide, or other source of lighting or illumination may be arranged on the inside face 712 around the perimeter of the mirror 710.

A switch 724 is provided either on the container portion 702 or the cover 704 for activating the lighting source. For example, in the illustrated embodiment the switch 724 is a pushbutton switch disposed on the inside face 712 of the cover 704. The switch 724 may be configured for manual operation, or for automatic operation such as illuminating the lighting source when the cover 704 is opened.

A receiving connector 726 is provided in electrical connection with the battery cells 120, or with a battery circuit that may include a switch, indicator lamp, or other features along with the battery cells 120, for connection with a mating connector of an accessory or accessory adaptor cord.

In the illustrated embodiment, a charging adapter 300 is shown having a mating connector 312 for connection to the receiving connector 726 and an accessory connector 314 for connection to an electrical connector or port of a portable electronic device.

At least one indicator light 728 may be provided for indicating a low battery status, a fully charged or charging complete status, a charging in progress status, or another status of the device. A single bi- or multi-colored LED, for example, may indicate multiple statuses of the device.

It will be understood that the above-described embodiments of the invention are illustrative in nature, and that modifications thereof may occur to those skilled in the art. Accordingly, this invention is not to be regarded as limited to the embodiments disclosed herein, but is to be limited only as defined in the appended claims.

We claim:

1. A mobile power source for charging a portable electronic device, comprising:
a battery housing;
a battery power source disposed in said battery housing;
a receiving connector disposed in said battery housing and configured to receive a mating connector of a lighting accessory or a charging element of a rechargeable device in electrical connection with an electrical circuit including said battery power source to supply electrical power from said battery power source to said receiving connector;
a light source disposed in said battery housing and in electrical connection with said electrical circuit, the light source being configured to emit light from said battery housing; and
a switch disposed in said battery housing and electrically connected to said electrical circuit to selectively supply electrical power from said battery power source to said light source.

2. The mobile power source according to claim 1, wherein said battery power source comprises a battery carrier configured to receive at least one battery cell in electrical connection with said electrical circuit.

3. The mobile power source according to claim 2, wherein said battery carrier is removably disposed in said battery housing.

4. The mobile power source according to claim 1, further comprising a lighting accessory configured for connection to said battery housing.

5. The mobile power source according to claim 4, wherein said battery housing includes a container, and said lighting accessory is hingably attached to said battery housing to form a cover for said container.

6. The mobile power source according to claim 5, further comprising a plurality of lighting sources disposed on an inner face of said lighting accessory.

7. The mobile power source according to claim 4, wherein said lighting accessory comprises:
a lamp housing;
at least one lamp disposed in said lamp housing;
a mating connector disposed on said lamp housing, the mating connector being configured to mechanically connect said lamp housing to said battery housing and to electrically connect said lamp with said battery power source.

8. The mobile power source according to claim 1, wherein said battery power source comprises a plurality of battery cells.

9. The mobile power source according to claim 1, wherein said battery power source comprises four battery cells arranged in series.

10. A mobile power source and lighting accessory kit, comprising:
a battery pack comprising a battery housing, a battery power source disposed in said housing, a receiving connector in electrical connection with said battery power source; and
at least one lighting accessory configured for electrical and mechanical connection with said receiving connector.

11. The mobile power source and lighting accessory kit according to claim 10, wherein said at least one lighting accessory includes a flashlight attachment comprising a lamp housing, a lamp disposed in said lamp housing, and a mating connector, the mating connector being configured to mechanically connect said lamp housing to said battery pack and to electrically connect said lamp with said battery power source.

12. The mobile power source and lighting accessory kit according to claim 10, wherein said battery pack further comprises a light source disposed in said battery housing and in electrical connection with said electrical circuit, the light source being configured to emit light from said battery housing.

13. The mobile power source and lighting accessory kit according to claim 10, wherein said battery pack further comprises a switch disposed in said battery housing and electrically connected to said electrical circuit to selectively supply electrical power from said battery power source to said light source.

14. The mobile power source and lighting accessory kit according to claim 10, wherein said battery pack further comprises a switch disposed in said battery housing and electrically connected to said electrical circuit to selectively supply electrical power from said battery power source to said receiving connector.

15. The mobile power source and lighting accessory kit according to claim 10, further comprising at least one accessory power connector having a mating connector and an accessory connector, wherein said mating connector is configured for connection with said receiving connector, and said accessory connector is configured for connection with a portable electronic device, whereby when said mating connector is connected to said receiving connector and said accessory device is connected to a portable electronic device, said battery cells supply electrical power to said portable electronic device.

16. The mobile power source according to claim 1, further comprising at least one accessory power connector having a mating connector and an accessory connector, wherein said mating connector is configured for connection with said receiving connector, and said accessory connector is configured for connection with a portable electronic device, whereby when said mating connector is connected to said receiving connector and said accessory device is connected to a portable electronic device, said battery cells supply electrical power to said portable electronic device.

17. The mobile power source and lighting accessory kit according to claim 15, wherein said portable electronic device is a portable cellular telephone.

18. The mobile power source according to claim 16, wherein said portable electronic device is a portable cellular telephone.
